(19) United States
(12) Patent Application Publication
(10) Pub. No.: US 2004/0006618 A1
(43) Pub. Date: Jan. 8, 2004

(54) Network construction system

(75) Inventors: Mariko Kasai, Ebina (JP); Yoshinori Watanabe, Chigasaki (JP); Yoshiyuki Nakano, Yokohama (JP); Kiyoto Osada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/439,849

(22) Filed: May 15, 2003

(30) Foreign Application Priority Data
Jul. 3, 2002 (JP) 2002-194093

(51) Int. Cl. G06F 15/173

(52) U.S. Cl. 709/223

(57) ABSTRACT

In a network where one security policy applies to a plurality of network devices, a system is provided for generating a setup parameter set for such network devices that complies with their specifications and provides improved connectivity or interoperability. The system enables registering the specifications for network devices and the information on connectivity and interoperability among them. The specifications are stored, as is information on connectivity and interoperability. The results are used to check compatibility and establish a setup parameter set which has fewer incompatibilities.

### CROSS-REFERENCE TO RELATED APPLICATIONS

This application claims priority from Japanese patent application, No. 2002-194093 filed Jul. 3, 2002, the contents of which are incorporated herein by reference.

### BACKGROUND OF THE INVENTION

This invention relates to a system and a method for facilitating the construction of a network comprising a plurality of network devices which have different specifications or which are made by different manufacturers.

With advances in internet applications and technology, a variety of network devices are being developed, resulting in an ever-increasing variety of software designed to work on such devices. As a result, it is becoming extremely complex to configure a network out of a variety of network devices and associated software and to set up all of them properly so that they will work as required.

Gaining attention in recent years are a Virtual Private Network (VPN), which, constructed as a virtual network for private use on a public internet, offers enhanced levels of security by using various security technology such as encryption and user authentication, and VPN devices which incorporate such technology. Examples of encryption technology include the cipher communication protocol IPsec, defined in RFC2401 published by IETF. While IPsec is implemented on a number of VPN devices, IPsec itself is complex and requires an elaborate setup operation. The problem of complexity in setup operation is compounded by the fact that different manufacturers of VPN devices use different ways of setting them up for IPsec.

One prior art solution to the problem of complexity in setting up network devices, such as a router, is the use of SNMP (Simple Network Management Protocol) (RFC1157), which allows one management terminal to manage and operate a number of network devices. Another solution is described in “Distributed Object Technology for Networking,” IEEE Communications, Vol. 36, Issue 10, October 1998, pp. 100-111, which pertains to a method for managing distributed network devices.

These prior art solutions require the manager of the network devices to issue the same set of commands to each one of them, thus falling short of eliminating the complexity in the setup operation. Furthermore, for each VPN tunnel, it is necessary to set the security policy in the network devices on both VPN tunnel endpoints. In effect, there is one-to-two correspondence between each security policy and VPN devices, which means that the two VPN devices on both tunnel endpoints must be so set up that they are inter-connectable and interoperable. To ensure connectivity and interoperability, it is essential to assure that there are no incompatibilities between the two VPN devices resulting from differences in the level of support of the IPsec or in manufacturer.

### BRIEF SUMMARY OF THE INVENTION

This invention provides an easier approach for the system manager to construct an easy-to-manage network system, in which there is more than one network devices to set up for each security policy. The approach considers the specifications for their support levels, connectivity and interoperability, then automatically generates a setup parameter set for each such network device.

In particular, the present invention provides a network construction system residing on a management server that manages a plurality of network devices, wherein the specifications for the network devices and the information on the connectivity and interoperability among such devices are registered in a database. The network device setup parameter set for a plurality of target network devices intended to be set up is entered from outside and is checked against the specification of its corresponding network devices, as well as their corresponding information about connectivity and interoperability. The checking assures compatibility, and allows a final setup parameter set to be generated for the target network devices. The present invention also allows the system manager to set up network devices without need for concern about their specifications, connectivity or interoperability. These and other benefits are described below.

### BRIEF DESCRIPTION OF THE DRAWINGS

FIG. 1 illustrates a VPN path setup parameter set.

FIG. 2 is an example of the organization of a model database.

FIG. 3 is another example of the organization of the model database.

FIG. 4 illustrates a process flow for the compatibility checking unit.

FIG. 5 shows an example of VPN path setup error messages.

FIG. 6 illustrates the configuration of the setup parameter set generation unit.

FIG. 7 is an example of a window presenting the results of generating a VPN path setup parameter set.

FIG. 8 illustrates an application of the invention applied to costruction of a VPN.

FIG. 9 illustrates a user operation according to a preferred embodiment of the invention.

FIG. 10 illustrates another example of the model database.

FIG. 11 illustrates an example of an overall configuration of the network construction system.

FIG. 12 illustrates the process flow for the configuration shown in FIG. 11.

### DETAILED DESCRIPTION OF THE INVENTION

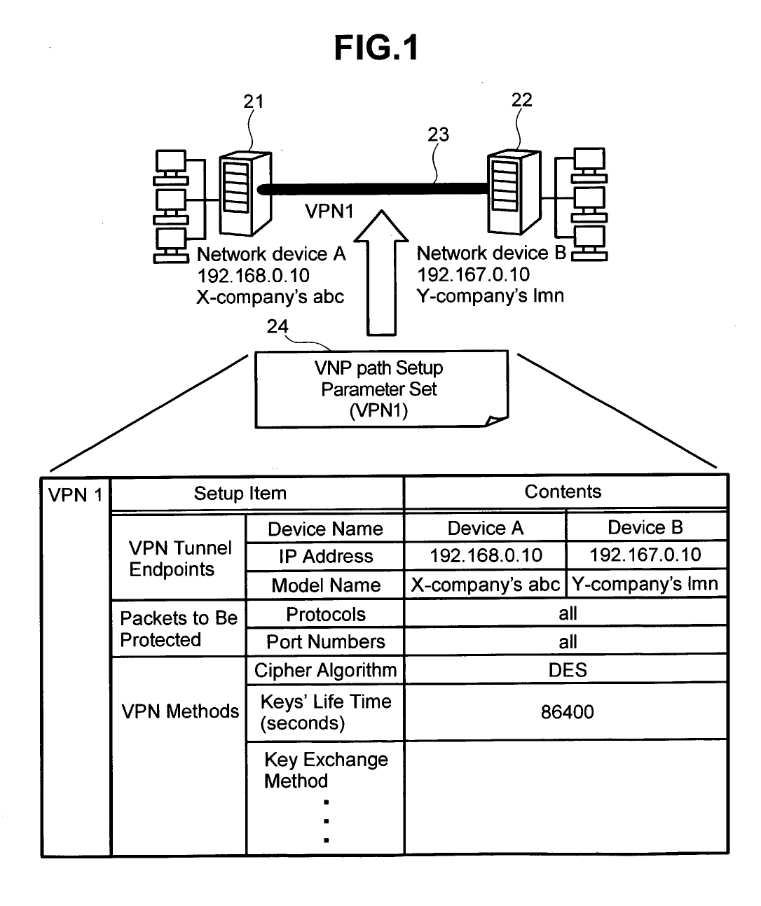

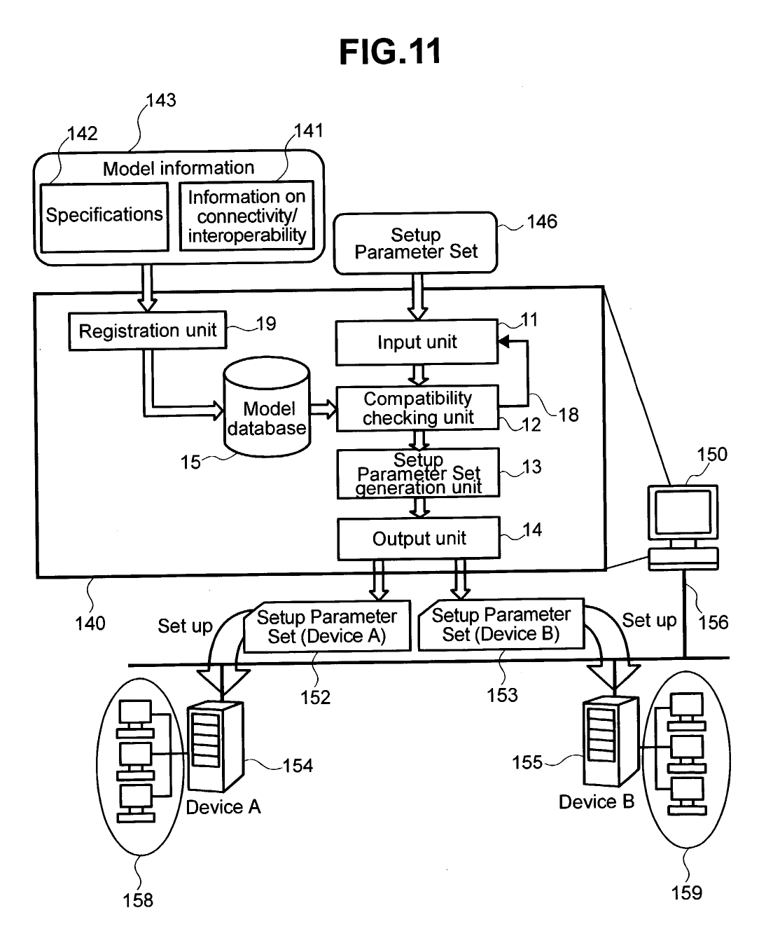

The preferred embodiment of the present invention is described below with reference to FIGS. 1 through 12. FIG. 11 illustrates an example of a configuration of a network construction system according to a preferred embodiment of this invention. In FIG. 11, reference numeral 150 denotes a management server in which a network construction system 140 resides, while numerals 154 and 155 denote network device A and network device B, respectively. Both devices are managed by the management server 150. Numeral 156 denotes a network such as a LAN (Local Area Network) that interconnects the management server 150 and the network devices 154 and 155 being managed. Whereas FIG. 11 shows only two network devices being managed, there can be more than two. Furthermore, an additional set of apparatus 158 or 159 may be attached to the network device A 154 or network device B 155, respectively.

An information processing apparatus comprising a CPU, a storage unit, an input apparatus, such as a keyboard, and an output apparatus, such as a display, may be used as the management server 150. According to a preferred embodiment of the invention, the network construction system 140 includes the CPU executing a program stored in the storage unit. The program may be stored in the storage unit beforehand or loaded from an external storage medium or another information processing apparatus via a telecommunication medium on demand.

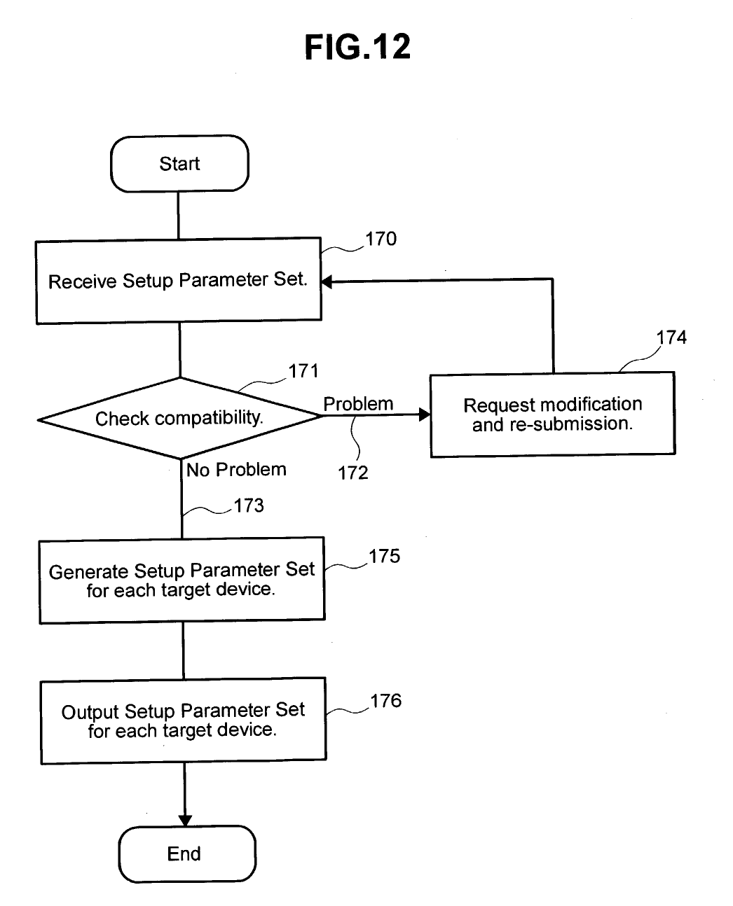

The network construction system 140 comprises an input unit 11, a compatibility checking unit 12, a setup parameter set generation unit 13, an output unit 14, a model database 15 holding model information 143, and a registration unit 19 for registering model information 143. The inputs to the network construction system 140 include model information 143 and network setup parameter set 146 with which the user requests a pair of target network devices to be set up. The output from the network construction system 140 comprises setup parameter sets 152 and 153 for the target network devices. The model information 143 is the information on the model of a network device to be registered in the model database 15 and includes the specifications of the model 142 and the information on the model's connectivity and interoperability with other devices 141. The process flow of how the network construction system 140, when given a setup parameter set for two target network devices A 154 and B 155, generates a final setup parameter set for them is described below with reference to FIGS. 11 and 12.

The model specifications 142 for the two network devices A 154 and B 155 and the information 141 on their connectivity and interoperability with other devices are registered beforehand into the model database 15 via the registration unit 19. First, the input unit 11 performs input processing on the setup parameter set 146 for the target network devices A 154 and B 155 (step 170). Next, the compatibility checking unit 12 checks, by referring to the model database 15, compatibility between the input information and the information in the model database, i.e., whether the setup parameter set 146 agrees with the specifications for the network devices A 154 and B 155 and whether the setup parameter set 146 agrees with the information on their connectivity and interoperability (step 171).

Compatibility checking as to the specifications consists in checking whether the setup parameter set 146 falls within the ranges supported by the network devices A 154 and B 155, which are contained in the model specifications 142 held in the model database 15. Compatibility checking as to connectivity and interoperability consists in checking whether setup parameter set 146 matches any of the connectivity or interoperability problems pertaining to the network devices A 154 or B 155, which are contained in the connectivity and interoperability information 141 held in the model database 15.

If there is any incompatibility, i.e., if there is any problem with compatibility (step 172), then a request for modifying the setup parameter set 146 and submitting the modified setup parameter set is issued (step 174). If there is no incompatibility, i.e., if there is no problem with compatibility (step 173), then the setup parameter set generation unit 13 generates, out of the given setup parameter set 146, final setup parameter set 152 and 153 for the network devices A 154 and B 155, respectively (step 175). Finally, the output unit 14 outputs the final setup parameter set 152 for the network device A 154 and the final setup parameter set 153 for the network device B 155 (step 176).

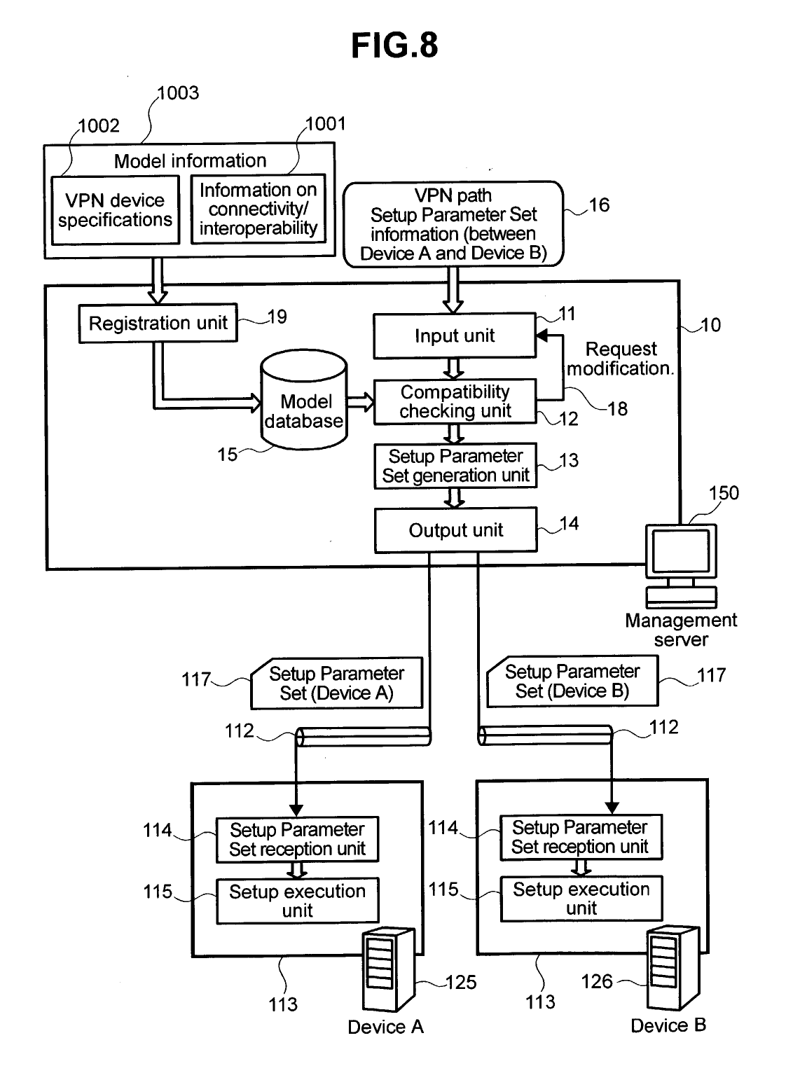

Another embodiment of the present invention, which is applied to the construction of a VPN, is described below. FIG. 8 is a block diagram showing the configuration of a VPN construction system 10 according to this embodiment. For ease of explanation, like reference numbers denote like or corresponding items, and the detailed descriptions of them are basically omitted here to avoid redundancy. The VPN path setup parameter set 16, which defines the security policy for the VPN, is entered into the VPN construction system 10 via the input unit 11. Alternatively, an edit unit can be added to allow the user to enter the setup parameter set in a conversational mode.

The VPN path setup parameter set 16 comprises the information on the pair of VPN tunnel endpoints, the information on the packets to be protected, and the information on the VPN methods. More specifically, the information on the pair of VPN tunnel endpoints includes the device name, IP address, and model name for each endpoint; the information on the packets to be protected includes the protocols applied to the packets transmitted over the VPN and the port numbers; the information on the VPN methods includes the cipher algorithm, the life time of the keys used in encryption/decryption, and the key exchange method. It is assumed that the VPN path setup parameter set 16 has a model-independent format, i.e., a format that does not depend on the make or model of the network device to be set up. This allows the user to set up VPN without being concerned about differences in model or vendor.

FIG. 1 illustrates the composition of the VPN path setup parameter set 24, where a VPN1 23 is to be constructed between a VPN device A 21 and a VPN device B 22. The table in FIG. 1 shows that the devices at the endpoints of the VPN1 23 are the VPN device A 21 and the VPN device B 22, with the IP addresses 192.168.0.10 and 192.167.0.10, respectively, and the model names “X-company abc” and “Y-company lmn,” respectively. It also shows that all of the packets are to be protected, that DES is employed as the cipher algorithm, and that the keys' lifetime is 86,400 seconds.

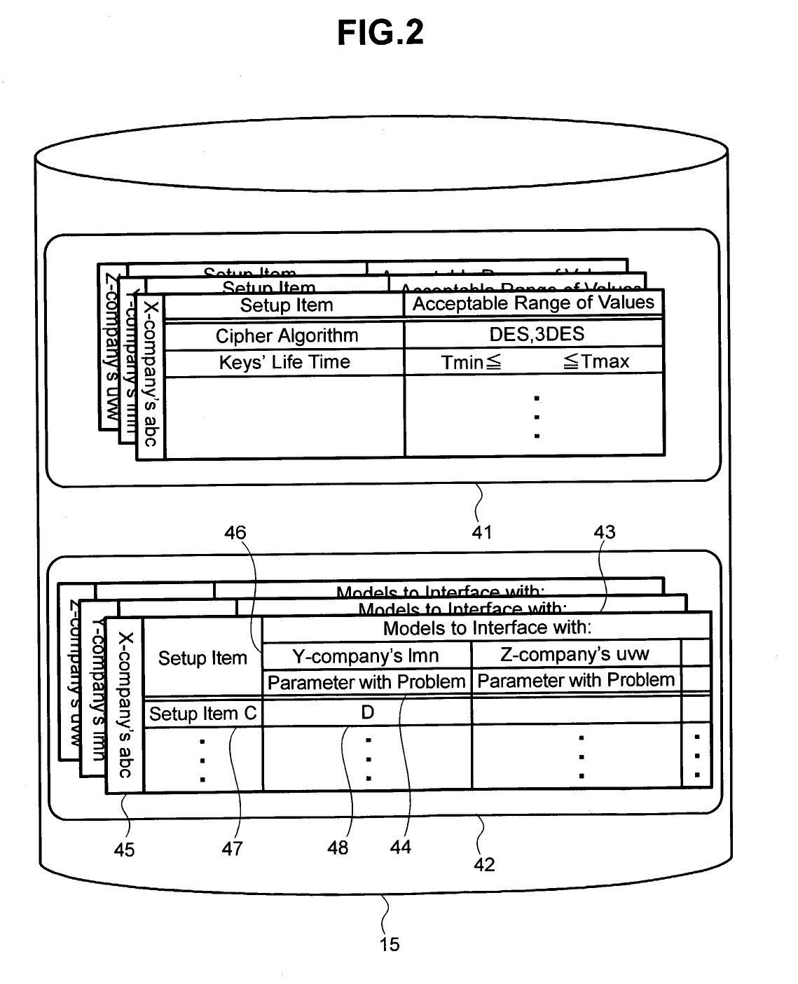

FIG. 2 shows how information is organized inside the model database 15. The database includes a section 41 for storing the specifications by model, and a section 42 for storing the information on connectivity and interoperability. While most VPNs employ a standard cipher communication protocol (IPsec), the scope and level of support for such protocol differ from model to model, and from vendor to vendor. For effective management of such differences, the specifications 41 for all models are stored via the registration unit 19 into the model database 15.

Furthermore, while all the network devices in a VPN support the standard cipher communication protocol (IPsec), there can be minute differences in implementation among them. As a result, they may encounter some problems when they actually communicate with each other, even though they comply with the protocol specifications. From the user's perspective, it would be desirable to provide a means for preventing such problems. Thus, known problems in connectivity and interoperability are also registered as information on setup restrictions in the model database 15. In summary, for each model, the problems that are known regardless of the other model with which a system is to communicate are registered as part of the specification 41 in the model database 15. The problems that may be encountered only for a certain combination of models and/or parameters are registered as part of the information on connectivity and interoperability 42 in the model database 15.

The information on connectivity and interoperability 42 is arranged by model and, for each model, in a table format consisting of a number of columns and a number of rows. One of the columns, for example the leftmost column, is used to hold setup items, whereas each of the other columns 43, which corresponds to one of the other models, is used to hold the parameters 44 which will or may cause a connectivity or interoperability problem with that other model. For example, the problem: “Although on the specification level X-company's Model abc should be able to communicate with Y-company's Model lmn even when value D is specified for setup item C, in actuality X-company's Model abc cannot communicate with Y-company's Model lmn unless value F is specified for setup item E” is registered in the table corresponding to X-company's Model abc 45. This can be achieved by allocating one column to “Y-company's Model lmn” 46 and one row to setup item C 47 and entering “value D[ 48 in the cell at the crossing. In this manner the values which tend to cause connectivity or interoperability problems when used in combination with certain other models are registered together with the other models as combinations in the model database 15.

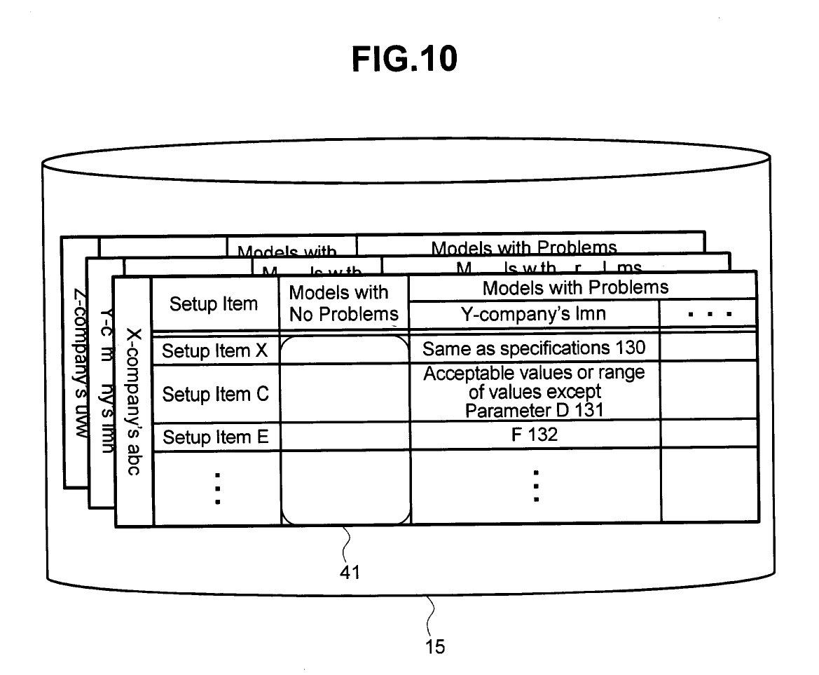

In an alternative embodiment, the model database 15 can be organized to contain only “acceptable values or range of values” for each setup item, effectively combining the model specifications 41 and the information on connectivity and interoperability 42, as shown in FIG. 10. In combining these two sets of information, for a network device model with which there are no connectivity or interoperability problems, the entire column for that model contains the same value set as the specifications 41. The column for a network device model with which there are some connectivity or interoperability problems contains, for each setup item with a potential problem, either the acceptable values or range of values, which means the values or range of values given in the specifications except the values with a problem, or the essential values, and for each setup item without any potential problem, the same value set as the specifications 41.

For example, the problem: “Although on the specifications level, X-company's Model abc should be able to communicate with Y-company's Model lmn even when value D is specified for setup item C, in actuality, it cannot” is represented in the model database 15 by entering in the cell for setup item C under the column for Y-company's Model lmn the values or range of values 131 allowed by the specifications except value D. Similarly, the tip: “X-company's Model abc cannot communicate with Y-company's Model lmn unless value F is specified for setup item E” is represented in the model database 15 by entering value F 132 in the cell for setup item E under the column for Y-company's Model Imn. If setup item X does not have any potential connectivity or interoperability problem between X-company's Model abc and Y-company's Model lmn, the same values or range of values as the specifications 130 is entered in the cell for setup item X under the column for Y-company's Model lmn.

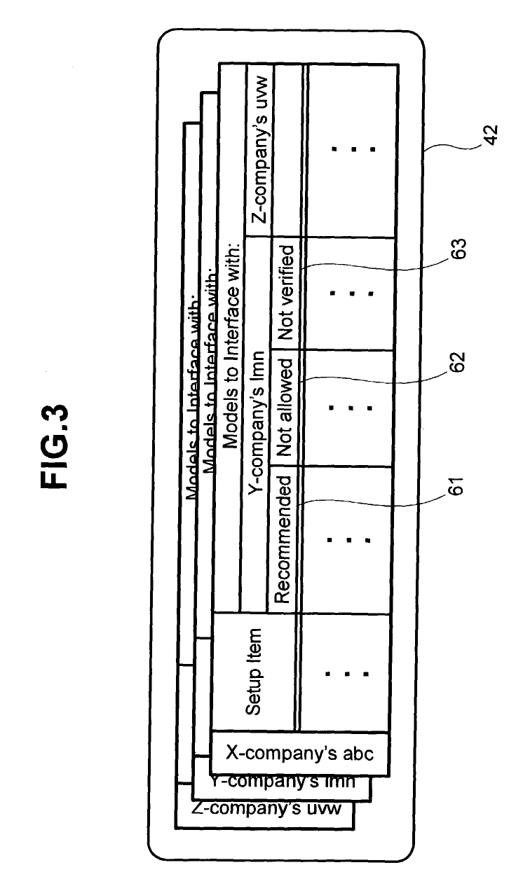

In practice, it is often difficult to create a complete database with a complete set of information on connectivity and interoperability by verifying normal operation for all the possible combinations of network devices with all the possible combinations of values. To solve such a problem, an alternative embodiment of the present invention provides new categories “recommended” 61 and “not verified” 63 in the table compiling the information on connectivity and interoperability 42, as shown in FIG. 3. The values for which normal operation has been verified are entered under “recommended” 61, the values for which normal operation has not been verified are entered under “not verified” 63, and the values for which a known problem exists are entered under “not allowed” 62.

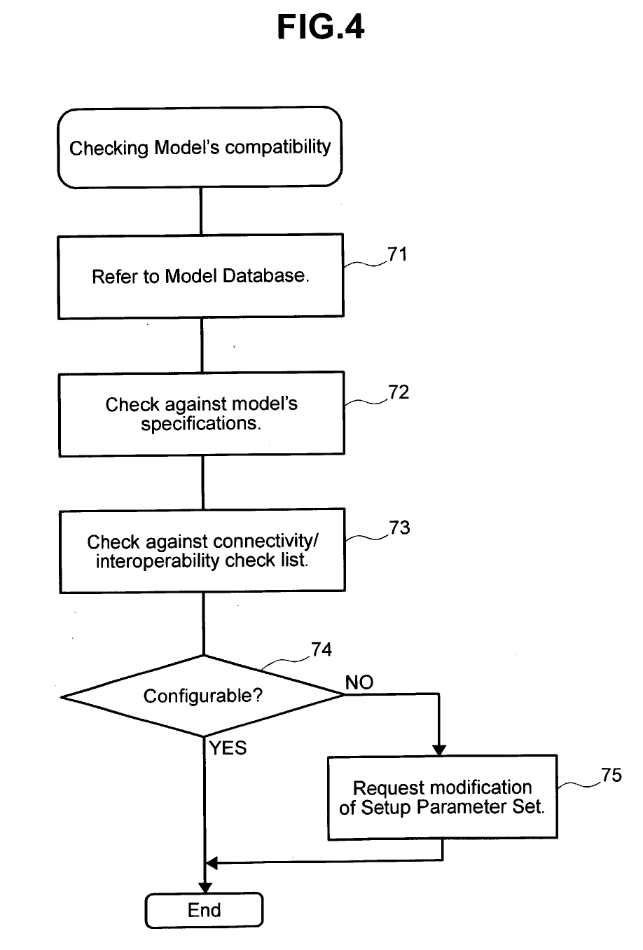

FIG. 4 shows the flow of the process that takes place in the compatibility checking unit 12. First, the model database 15 is referred to using the model name of one of the VPN tunnel endpoints specified in the VPN path setup parameter set 16 (step 71) as the key. Next, by comparing the contents of the VPM path setup parameter set 16 with the model specifications 41 retrieved out of the model database 15, it is checked whether the given values can be used to set up the target network device (step 72). Then by comparing the contents of the VPN path setup parameter set 16 with the information on connectivity and interoperability 42 retrieved out of the model database 15, it is checked whether there are any connectivity or interoperability problems to be anticipated (step 73). While FIG. 4 shows step 72 and step 73 as two separate steps, they can be consolidated into one step for alternative embodiments employing the implementation of the model database 15 shown in FIG. 3 or FIG. 10, since all the necessary information (specifications 41 and connectivity and interoperability information 42) can be retrieved from the column or set of columns corresponding to the model with which the selected model will interface. Using the results of steps 72 and 73, it is finally determined whether the given VPN path setup parameter set 16 can be used as it is to set up the target network device (step 74), and if it cannot, a request is issued to the user to modify the VPN path setup parameter set 16 (step 75).

In the step requesting modification of the setup parameter set (step 75), a variety of means can be employed to notify the user that the VPN path setup parameter set as it was given is not suitable for setting up the target network device: displaying a message in text format, highlighting the problematic path on the network configuration chart, or sounding an audible alarm. All these are possible by using a display or an audio output apparatus attached to the management server 150.

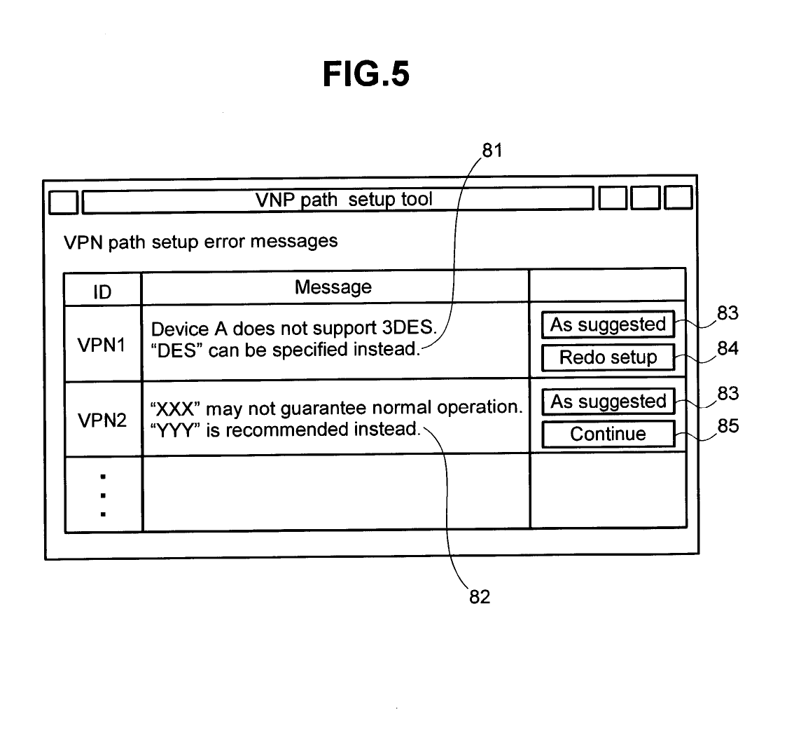

The message announcing that the VPN path setup parameter set given by the user is not suitable for setting up the target network device may additionally identify the parameter that has the problem or suggest an alternative values or range of values that would be acceptable. FIG. 5 shows examples of error messages that are issued together with a request for modification of the VPN path setup parameter set 16. The first message 81 indicates that the collation with the model specifications (step 72) has revealed that the target network device A does not support 3DES specified in the VPN path setup parameter set and recommends DES as an alternative. The second message 82 indicates that the collation with the connectivity and interoperability information (step 73) has revealed that “XXX” specified by the user might cause a connectivity or interoperability problem with the other network device and recommends “YYY” as a tried alternative.

It is further desirable to provide, on the error message display, additional buttons for ease of operation, such as an “As suggested” button 83, which should be clicked to tell the network construction system to apply the suggested modification, a “Redo setup” button 84, which should be clicked for the user to modify the VPN path setup parameter set 16 and submit the modified version, and a “Continue” button 85, which should be clicked to tell the network construction system to proceed ignoring the error message.

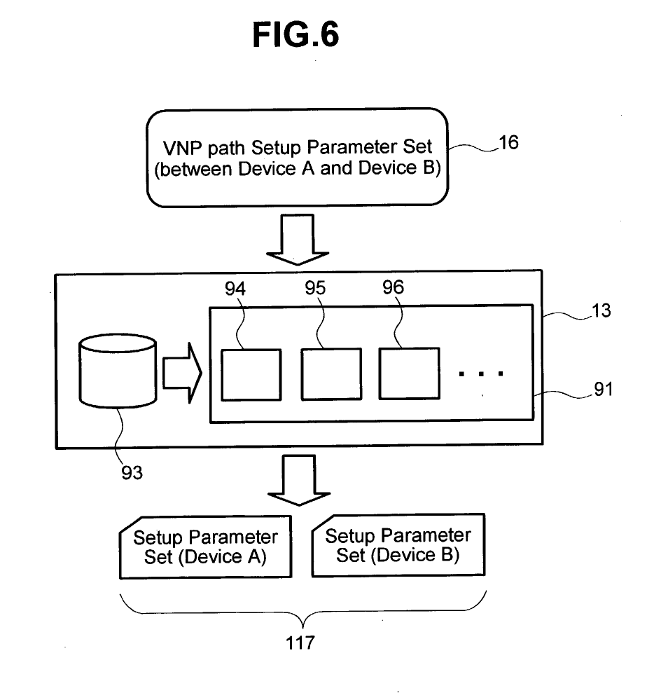

The setup parameter set generation unit 13 comprises setup parameter set generation modules 94, 95, and 96, which are collectively referred to as a setup parameter set generation module group 91, as shown in FIG. 6, and generates device setup parameter set 117 for each of the target network devices out of the VPN path setup parameter set 16 that has been determined by the compatibility checking unit 12 to be suitable. Some models may have their original setup items or more detailed setup items than those provided in the VPN path setup parameter set 16. Therefore, the setup parameter set generation unit 13 also includes storage 93, in which values corresponding to such original setup items or such more detailed setup items are stored. When generating device setup parameter set 117, the setup parameter set generation unit 13 retrieves information from the storage 93 as necessary to supplement what is specified in the VPN path setup parameter set 16. Alternatively, the model database 15 may be organized to contain such values corresponding to such original setup items or such more detailed setup items, in which case there is no need to provide the storage 93 in the setup parameter set generation unit 13.

The output unit 14 outputs the setup parameter set 117 thus generated for each target network device. The registration unit 19 registers the specifications 1002 for VPN devices and the information on connectivity and interoperability 1001 into the model database 15 in its format.

The VPN construction system 10 is described in detail below. The input unit 11 receives the VPN path setup parameter set 16. The compatibility checking unit 12 refers to the model database 15 and determines whether the VPN path setup parameter set 16 is suitable for setting up target network devices. If it determines that the VPN path setup parameter set 16 is not suitable, then it instructs the input unit 11 to request the user to modify the VPN path setup parameter set. If it determines that the VPN path setup parameter set is suitable, then the setup parameter set generation unit 13 generates, out of the VPN path setup parameter set 16, setup parameter set 17 for each target network device in the latter's format, which is then output by the output unit 14.

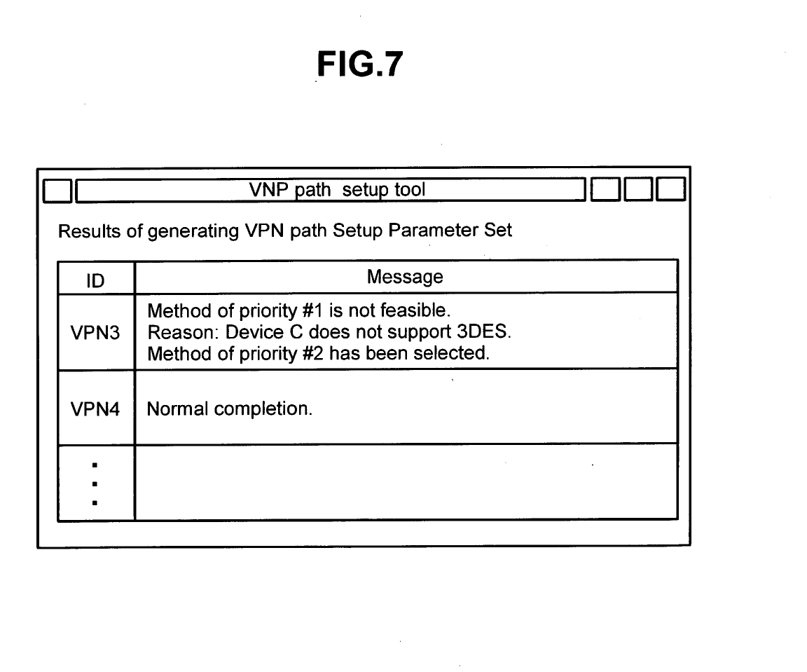

Alternatively, the VPN path setup parameter set 16 may be expanded to include more than one VPN method arranged according to a priority scheme. In this case, the compatibility checking unit 12 selects the highest-priority VPN method that is suitable, out of which the setup parameter set generation unit 13 generates the final setup parameter set. The output unit 14 may produce on the display unit attached to the management server 150 a message indicating how and why the final setup parameter set has bee generated, as shown in FIG. 7.

In terms of the actual application of the setup parameter set, the VPN construction system 10 may be organized in a number of ways, such as manually, in which case the user manually applies the generated setup parameter set to the target network devices, or using a setup agent 113 that resides on the target network device and does the setup on behalf of the user. The setup agent 113 comprises a setup parameter set reception unit 114 and a setup execution unit 115. The output unit 14 first establishes a secure communication path 112 between itself and the setup parameter set reception unit 114 on each of the target network devices 125 and 126 by employing security measures such as authentication, digital signature, and encryption, and then sends the setup parameter set 117 via the secure communication path. In each of the target network devices 125 and 126, the setup parameter set reception unit 114 receives the setup parameter set 117, and using the setup parameter set 117, the setup execution unit 115 performs the actual setup operation.

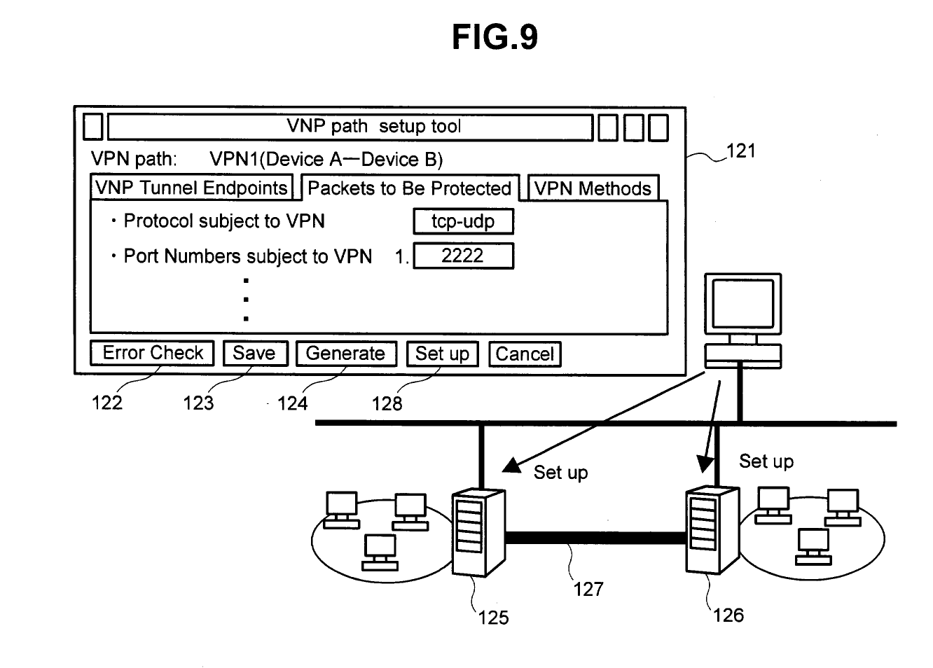

The user's operation when the VPN construction system 10 further includes a conversational user interface is described below with reference to FIG. 9. The user, who wishes to construct a VPN 127 between a network device A 125 and a network device B 126, calls up a setup window 121 on the display attached to the management server 150, enters VPN path setup parameter set 16 and clicks an error check button 122 on the window. The VPN construction unit 10 in turn performs, in the compatibility checking unit 12, specification check (step 72) and connectivity/interoperability check (step 73), determines whether the given VPN path setup parameter set 16 is suitable for the network device A 125 and the network device B 126 (step 74), and then informs the user of the results using the VPN path setup error message window shown in FIG. 5.

If one of the specified values is found to have a problem and needs to be modified or replaced, the user modifies or replaces it by clicking the “As suggested” button (the actual modification will be done by the VPN construction system) or the “Redo setup” button (the user will manually do the modification). If there are no errors, the user clicks the “Generate” button 124, which causes the VPN construction system 10 to generate setup parameter set for the network device A 125 and setup parameter set for the network device B 126 in the setup parameter set generation unit 13 and then to output them through the output unit 14. If the VPN construction system 10 supports the setup agent feature, the user then clicks the “Set up” button 128, which causes the VPN construction system 10 to send, through the output unit 14, the setup parameter set 117 for the network device A and the setup parameter set 117 for the network device B to the setup information reception unit 114 of their respective network devices. The setup execution unit 115 for the network device A 125 and the setup execution unit 115 for the network device B 126 in turn set up their respective network devices accordingly.

Whereas the above description pertains to an embodiment where the setup parameter set for network devices is generated chiefly from the VPN path setup parameter set given by the user, the VPN construction system 10 may alternatively incorporate a set of security measures based on a security policy, such that in combination with other apparatuses or other programs for generating setup parameter set for security-enhancing products (such as a firewall, a VPN apparatus, and a virus checker), the setup parameter set for the VPN apparatus is selected out of the setup parameter set generated for the security-enhancing products and is added to the VPN path setup parameter set to be input to the VPN construction system 10.

There are a variety of ways of updating the model database 15. For example, the specification for any new network device models and the information on connectivity and interoperability involving any new devices can be distributed through the WWW (Worldwide Web), a flexible disk or another storage medium, and then incorporated into the model database 15 by the registration unit 19. Similarly, the contents of the setup parameter set generation module group 91 can be updated remotely if they are sent to the VPN construction system 10 together with an installer (a program for installing a piece of software) through the WWW (World-wide Web), a flexible disk or another storage medium.

The specification and drawings are to be regarded as an illustrative, rather than a restrictive, explanation of the invention. It will, however, be evident that various modifications and changes may be made thereto without departing from the spirit and scope of the invention as set forth in the claims.

What is claimed is:

1. A network construction system residing in a management server for managing a plurality of network devices, the network construction system comprising:
a registration system which registers in a database the specifications for the network devices and information on the connectivity and interoperability among the network devices;
apparatus which receives an externally entered network device setup parameter set for setting up a plurality of target network devices; and
a checking system which checks compatibility among the network device setup parameter set, the specifications for the target network devices, and the information on the connectivity and interoperability among the target network devices, and in response generates a parameter set for setting up the target network devices.

2. The network construction system of claim 1 further comprising a display coupled to the checking system which displays results of checking the compatibility among the network device setup parameter set, the specifications for the target network devices, the compatibility among the network device setup parameter set, and the information on the connectivity and interoperability among the target network devices, and also displays, if an incompatibility is found, alternative setup values.

3. The network construction system of claim 1 further comprising a transmitter to transmit the parameter set to the target network devices.

4. The network construction system of claim 1 wherein the setup information and the parameter set generated for setting up the target network devices include information on at least one of the cipher communication method and the key management method.

5. The network construction system of claim 1 wherein the information on connectivity and interoperability is determined by actual results of interconnection and interoperation.

6. The network construction system of claim 1 wherein the checking system retrieves values compatible with the target network devices from the database by specifying the target network devices.

7. A method for constructing a network that includes a plurality of network devices and a management server for managing the plurality of network devices, the method comprising:
storing information about specifications for the network devices and information about the connectivity and interoperability among the network devices in a database;
receiving an external network device setup parameter set for setting up a plurality of network devices;
checking compatibility between the network device setup parameter set and the specifications for the target network devices and compatibility between the network device setup parameter set and the information on the connectivity and interoperability;
if any incompatibility is found in either of the checking steps, modifying and re-submitting the setup parameter set;
generating a setup parameter set for each of the target network devices that has fewer problems in compatibility; and
using the setup parameter set thus generated.
